(19) United States
(12) Patent Application Publication
(10) Pub. No.: US 2024/0309903 A1
(43) Pub. Date: Sep. 19, 2024

(54) U-BOLT AND CONSTRUCTION METHOD

(71) Applicant: NIPPON TELEGRAPH AND TELEPHONE CORPORATION, Tokyo (JP)

(72) Inventors: Toshiki NAKANISHI, Tokyo (JP); Daiki KOBAYASHI, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/273,002

(22) PCT Filed: Jan. 25, 2021
(86) PCT No.: PCT/JP2021/002390

§ 371 Date: Jul. 18, 2023

(51) Int. Cl. F16B 31/02; F16B 35/00

(52) U.S. Cl. CPC F16B 31/02; F16B 35/00

(57) ABSTRACT

A U-bolt (10) according to the present disclosure is a U-bolt (10) fastened to a fastened object (2) which includes a body part (11) which includes a pair of shaft parts (111) aligned in a first direction and extending in a second direction orthogonal to the first direction, and a bridge part (112) that connects one ends of each of the pair of shaft parts (111); and a pair of screw parts (12) provided at the other ends of each of the pair of shaft parts (111), in which a part of a surface of the body part (11) constitutes a support surface (11B) that supports a supported object.

### TECHNICAL FIELD

The present disclosure relates to a U-bolt and an installing method.

### BACKGROUND ART

In the related art, a U-bolt has been used to fix a fastening object such as a pipe to a fastened object such as a frame or a wall surface. The U-bolt is a U-shaped bolt in which two linear shaft parts are connected by a bridge part. By inserting the shaft parts of the U-bolt into each of two through-holes provided in the fastened object in a state of sandwiching the fastening object inside the U-bolt, and fastening from each end part of the two shaft parts by a nut, the fastening object can be sandwiched and fixed by the U-bolt and the fastened object.

When the fastening object is fixed to the fastened object by the U-bolt, it is necessary to fix the U-bolt perpendicularly to the fastened object. However, since the U-bolt can only be tightened by one of the two shaft parts, it is difficult to evenly fix the U-bolt on the left and right.

ε of shaft parts A and B (strain EA of shaft part A and strain ε_{B} of shaft part B), when one (shaft part A) of the two shaft parts is first tightened with a torque wrench and then the other shaft (shaft part B) is tightened with the torque wrench.

As shown in FIG. 10, the shaft part A which has been tightened first is tightened more with a smaller torque than the shaft part B. That is, the relationship between the strain and the torque does not match between the right and left shaft parts A and B. Therefore, even if the fastening force of the nut is controlled by the torque wrench, since the nuts are alternately fastened to the two shaft parts, it is difficult to fix the U-bolt by equalizing the strain of the two shaft parts due to a difference in correlation between the strain and the torque in the shaft parts A and B.

As shown in FIG. 11, NPL 1 discloses a technique for stably fixing a U-bolt to make it difficult to cause a displacement in a vertical direction (an extending direction of the shaft part), by machining a tip of the shaft part of the bolt into a tapered shape.

### CITATION LIST

### Non Patent Literature

[NPL 1] Takeshi Yamada, 4 others, “Structural characteristics of steel plate-concrete composite floor slabs using checkered steel plates and U-bolts to prevent slipping”, Proceedings of the 3rd Road Bridge Slab Symposium, p 79-84, 2003

### SUMMARY OF INVENTION

### Technical Problem

When the U-bolt is fixed to a fastened object, as shown in FIG. 12, a displacement in a horizontal direction occurs, and the U-bolt may be fixed in a state of being inclined in the horizontal direction. The technique described in the above-mentioned NPL 1 is a technique for making it difficult to cause a vertical displacement, and it is difficult to suppress a horizontal displacement and to fix the U-bolt by equalizing the strains of the two shaft parts. In addition, when the U-bolt is used as an infrastructure facility, since periodic inspection and repair are required, if the U-bolt body is formed into a complicated structure, it takes time and labor for inspection and repair.

An object of the present disclosure made in view of the above-mentioned problems is to provide a U-bolt and an installing method capable of fixing the U-bolt, while suppressing complication of a structure of the U-bolt and equalizing strain of each of a pair of shaft parts.

### Solution to Problem

In order to solve the above problem, a U-bolt according to the present disclosure is a U-bolt fastened to a fastened object. The U-bolt includes a body part which includes a pair of shaft parts aligned in a first direction and extending in a second direction orthogonal to the first direction, and a bridge part that connects one ends of each of the pair of shaft parts; and a pair of screw parts provided at the other ends of each of the pair of shaft parts, in which a part of a surface of the body part constitutes a support surface that supports a supported object.

In addition, in order to solve the above problem, an installing method according to the present disclosure is an installing method of fastening a U-bolt to a fastened object, the U-bolt including a body part which includes a pair of shaft parts aligned in a first direction and extending in a second direction orthogonal to the first direction, and a bridge part that connects one ends of each of the pair of shaft parts; and a pair of screw parts provided at the other ends of each of the pair of shaft parts, a part of a surface of the body part being formed by a support surface that supports a supported object, the installing method including a step of disposing a level gauge which is the supported object, on the support surface; and a step of fastening the screw part with a nut, on the basis of levelness indicated by the level gauge.

In addition, in order to solve the above problem, a installing method according to the present disclosure is an installing method of fastening a U-bolt to a fastened object, the U-bolt including a body part which includes a pair of shaft parts aligned in a first direction and extending in a second direction orthogonal to the first direction, and a bridge part that connects one ends of each of the pair of shaft parts; and a pair of screw parts provided at the other ends of each of the pair of shaft parts, a part of a surface of the body part being formed by a support surface that supports a supported object, the installing method including a step of disposing a first gyro sensor which is the supported object, on the support surface; a step of disposing a second gyro sensor on the fastened object; and a step of fastening the screw part with a nut, on the basis of an angle detected by the first gyro sensor and an angle detected by the second gyro sensor.

### Advantageous Effects of Invention

According to the U-bolt and the installing method according to the present disclosure, the U-bolt can be fixed, while suppressing complication of a structure of the U-bolt and equalizing strain of each of the pair of shaft parts.

### BRIEF DESCRIPTION OF DRAWINGS

FIG. 1A shows an example of a U-bolt according to a first embodiment.

FIG. 1B is a diagram showing another example of the U-bolt according to the first embodiment.

FIG. 2A is a diagram showing an example which a level gauge is disposed on the U-bolt shown in FIG. 1A.

FIG. 2B is a diagram showing an example in which the level gauge is placed on the U-bolt shown in FIG. 1B.

FIG. 3 is a diagram showing a modified example of a support surface shown in FIG. 1A.

FIG. 4 is a flowchart showing an example of an operation for fastening the U-bolt according to the first embodiment.

FIG. 5 is a diagram showing a modified example of the U-bolt shown in FIG. 2A.

FIG. 6A is a diagram showing a modified example of the U-bolt shown in FIG. 2B.

FIG. 6B is a cross-sectional view of the U-bolt shown in FIG. 6A taken along line A-A.

FIG. 7A is a diagram showing an example of a U-bolt according to a second embodiment.

FIG. 7B is a diagram showing another example of the U-bolt according to the second embodiment.

FIG. 8 a diagram showing an example of a U-bolt according to a third embodiment;

FIG. 9 is a flow chart showing an example of an operation for fastening the U-bolt according to the third embodiment.

FIG. 10 is a diagram showing an example of a relationship between torque and strain of the shaft part.

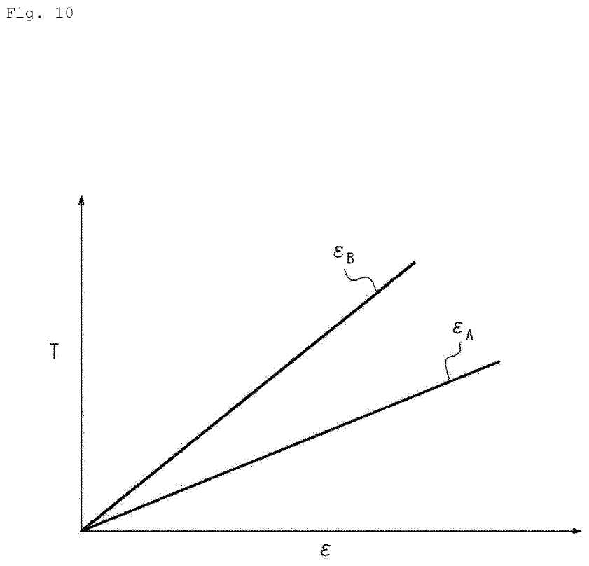

FIG. 11 is a diagram showing a vertical displacement of the shaft part of the U-bolt.

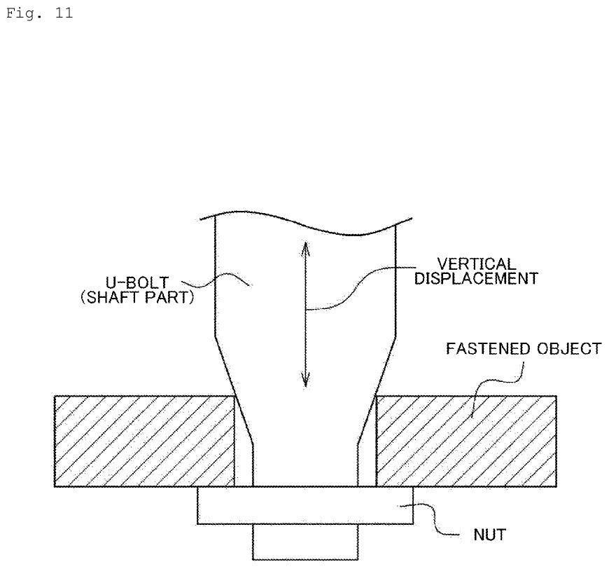

FIG. 12 is a view showing a horizontal displacement of the shaft part of the U-bolt.

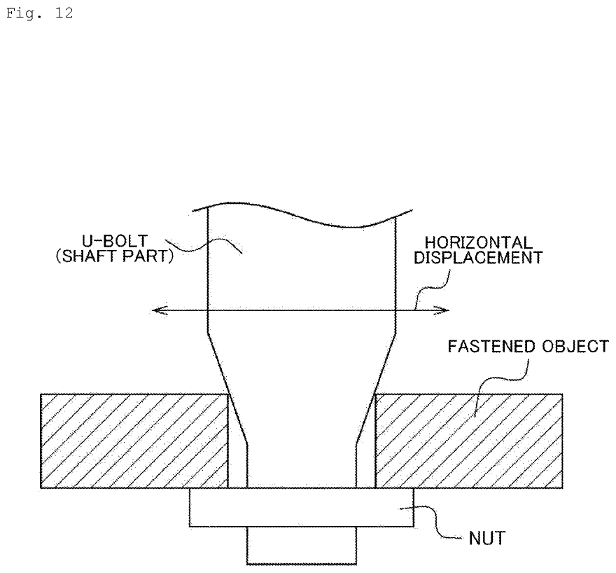

### DESCRIPTION OF EMBODIMENTS

A description will be given below of embodiments of the present disclosure with reference to the drawings.

### First Embodiment

### (Configuration of U-bolt)

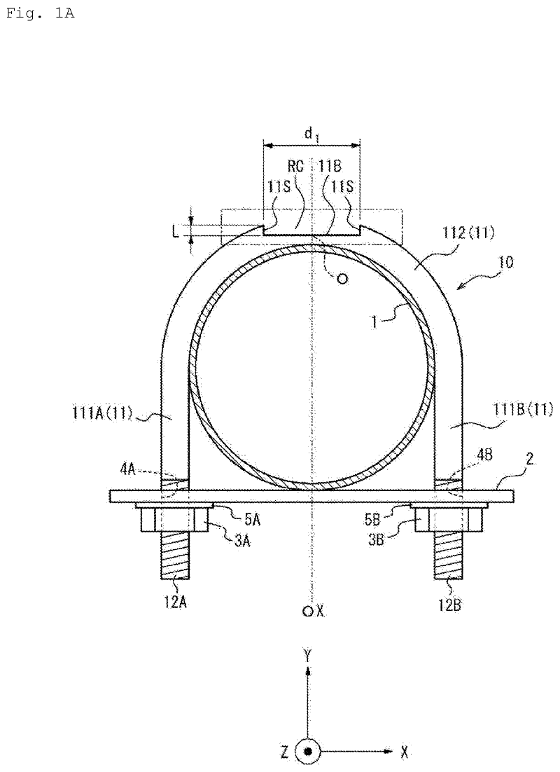

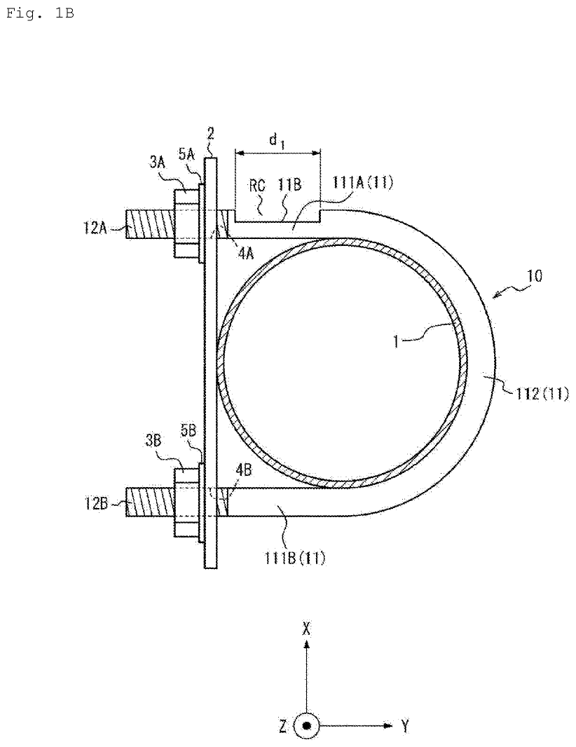

FIGS. 1A and 1B are diagrams showing configuration examples of a U-bolt 10 according to a first embodiment of the present disclosure.

The U-bolt 10 according to the present embodiment is made of a metal such as steel. As shown in FIGS. 1A and 1B, the U-bolt 10 includes a body part 11 including a pair of shaft parts 111A and 111B and a bridge part 112, and a pair of screw parts 12A and 12B.

The shaft part 111A and the shaft part 111B are disposed in a predetermined direction and extend in a direction orthogonal to the predetermined direction. Hereinafter, as shown in FIGS. 1A and 1B, a direction in which the shaft part 111A and the shaft part 111B are disposed side by side is referred to as an X-axis direction (a first direction), a direction in which the shaft part 111A and the shaft part 111B extend is referred to as a Y-axis direction (a second direction), and a direction orthogonal to the X-axis direction and Y-axis direction is referred to as a Z-axis direction (a third direction). Hereinafter, when the shaft part 111A and the shaft part 111B are not distinguished from each other, they are referred to as a shaft part 111. Hereinafter, the shaft part 111A and the shaft part 111B are collectively referred to as a pair of shaft parts 111.

The bridge part 112 connects respective one ends of the shaft part 111A and the shaft part 111B. The bridge part 112 is provided at one end of each of the shaft part 111A and the shaft part 111B, and can be formed into a semi-circular curved shape. Thus, the U-bolt 10 is formed in a U-shape.

The screw part 12A and the screw part 12B have a screw thread structure, respectively. The screw part 12A and the screw part 12B are provided at the other ends of the shaft part 111A and the shaft part 111B, respectively. Hereinafter, when the screw part 12A and the screw part 12B are not distinguished from each other, they are referred to as the screw part 12. In the following description, the screw part 12A and the screw part 12B are collectively referred to as a pair of screw parts 12.

A fastening object 1 such as pipe is disposed inside the U-shaped U-bolt 10 (in a space surrounded by the pair of inside shaft parts 111 and the bridge part 112). In a state in which the fastening object 1 is disposed inside the U-bolt 10, the screw part 12A and the screw part 12B penetrate from one surface side of the fastened object 2 into a pair of through-holes 4A and 4B provided in the fastened object 2 such as support hardware, and project to the other surface side of the fastened object 2. The screw part 12A and the screw part 12B protruding from the other surface side of the fastened object 2 are fastened by a nut 3A and a nut 3B. The nut 3A and the nut 3B have a screw thread structure screwed to the screw thread structure of the screw part 12A and the screw part 12B, respectively. Thus, the fastening object 1 is sandwiched and fixed between the U-bolt 10 and the fastened object 2. Hereinafter, when the through-holes 4A and 4B are not distinguished, they are referred to as a through-hole 4. When the nut 3A and the nut 3B are not distinguished, they are referred to as a nut 3. A washer 5A and a washer 5B may be sandwiched between the nut 3A and the nut 3B and the fastened object 2. When the washer 5A and the washer 5B are not distinguished, they are referred to as a washer 5.

In this embodiment, a part of the surface of the body part 11 constitutes a support surface 11B for supporting a supported object. Specifically, the support surface 11B supports the supported object in a substantially vertical direction in a state in which the U-bolt 10 is fastened to the fastened object 2. The “substantially vertical direction” indicates that a difference between the direction in which the support surface 11B supports the supported object and the vertical direction is equal to or less than a predetermined value. The support surface 11B can be formed by a plane. The support surface 11B can be formed in an arbitrary shape formed to abut on the supported object at one or more places to support the supported object in the substantially vertical direction, in a state in which the U-bolt 10 is fastened to the fastened object 2.

In the example shown in FIG. 1A, a part of the surface of the bridge part 112 constitutes a support surface 11B for supporting the supported object in the extending direction (the Y-axis direction) in which the shaft part 111 extends. In this example, the support surface 11B is a plane in which the extending direction in which the shaft part 111 extends is a perpendicular direction. For example, the support surface 11B of the bridge part 112 may be a plane including an apex O. The apex O is an intersection point of a virtual straight line OX extending in the Y-axis direction and including a middle point of the pair of shaft parts 111A and 111B and the support surface 11B. The center of the support surface 11B of a recess RC in the X-axis direction may be the apex O.

In the example shown in FIG. 1B, one shaft part 111A constitutes a support surface 11B for supporting a supported object in a direction (the X-axis direction) orthogonal to the extending direction (the Y-axis direction) in which the shaft part 111 extends. In this example, the support surface 11B is a plane in which the direction orthogonal to the extending direction in which the shaft part 111 extends is a perpendicular direction. Specifically, the support surface 11B of the shaft part 111A is positioned on an opposite side of the shaft part 111A to a side facing the other shaft part 111B, and the support surface 11B of the shaft part 111A is a plane in which a direction from one screw part 12A to the other shaft part 111B is a perpendicular direction, in the direction orthogonal to the extending direction.

In this embodiment, the body part 11 includes a recess RC, and the support surface 11B may be constituted by a bottom surface of the recess RC. In an example shown in FIG. 1A, the bridge part 112 has the recess RC, and the support surface 11B of the bridge part 112 is a bottom surface of the recess RC. In the example shown in FIG. 1B, the shaft part 111A has the recess RC, and the support surface 11B of the shaft part 111 is the bottom surface of the recess RC.

In this embodiment, the supported object disposed on the support surface 11B constituted in this way is a level gauge 6. The level gauge 6 measures levelness of the level gauge 6. Thus, the level gauge 6 measures the levelness of the support surface 11B on which the level gauge 6 is disposed. The levelness is a degree of horizontality, and may be indicated by, for example, an angle formed with the horizontal direction. The angle of direction in which the support surface 11B supports the supported object with respect to the extending direction is known. Therefore, a worker can recognize the angle of the extending direction in which the shaft part 111 extends with respect to the horizontal direction, on the basis of the levelness measured by the level gauge 6.

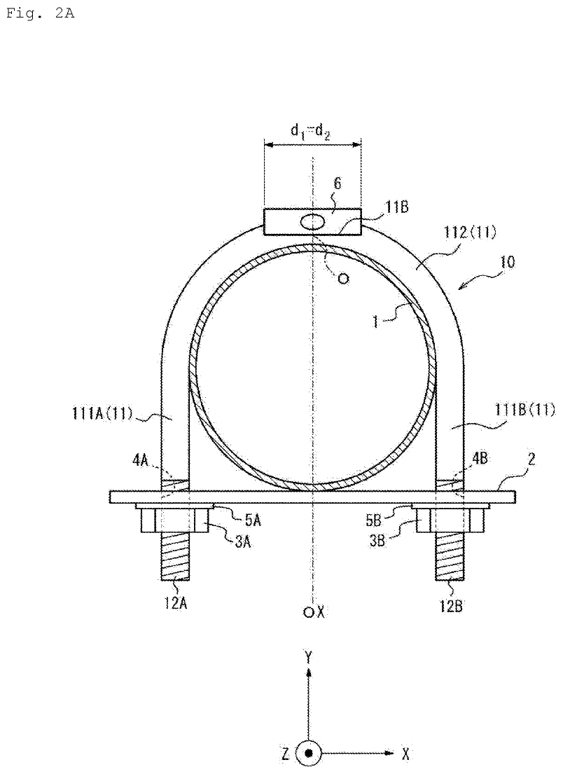

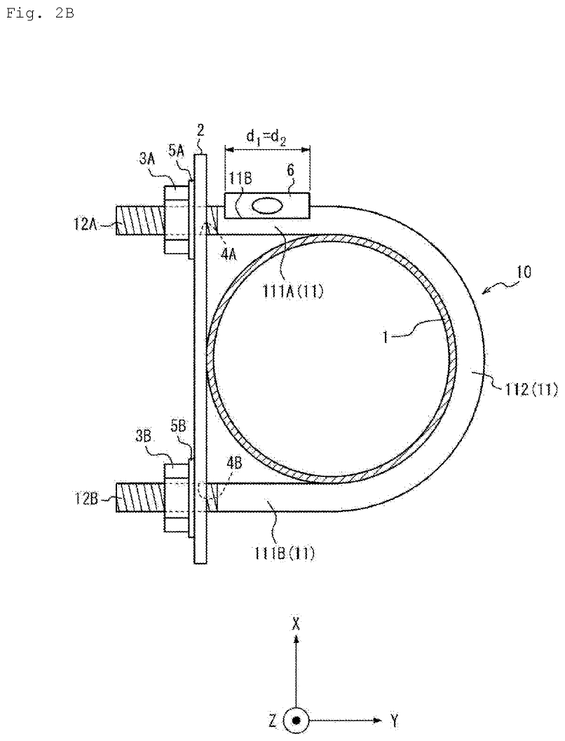

In a configuration in which the bridge part 112 has the support surface 11B as shown in FIG. 1A, the U-bolt is fastened to a fastened object 2 which is disposed with the Y-axis direction as a vertical direction and the Y-axis direction as a perpendicular direction. The level gauge 6 is disposed on the support surface 11B of the bridge part 112 as the supported body as shown in FIG. 2A. Specifically, the level gauge 6 is disposed on the support surface 11B so that the extending direction of a bubble tube of the level gauge 6 is substantially horizontal.

As shown in FIG. 1B, in the configuration in which the shaft part 111A has the support surface 11B, the U-bolt is fastened to the fastened object 2 disposed with the Y-axis direction as the horizontal direction and the Y-axis direction as the perpendicular direction. The level gauge 6 is disposed on the support surface 11B of the shaft part 111A as the supported body as shown in FIG. 2B. Specifically, the level gauge 6 is disposed on the support surface 11B so that the extending direction of the bubble tube of the level gauge 6 is substantially horizontal.

A length d₁ of the support surface 11B is equal to or longer than a length d₂ of the level gauge 6. The length d₂ of the level gauge 6 is a length in the extending direction of the bubble tube of the level gauge 6. As shown in FIGS. 1A and 1B, the length d₁ of the support surface 11B can be substantially the same as the length d₂ of the level gauge 6. Thus, the level gauge 6 is suppressed from being displaced in a direction parallel to the support surface 11B in a state of being disposed on the support surface 11B, and is stably supported.

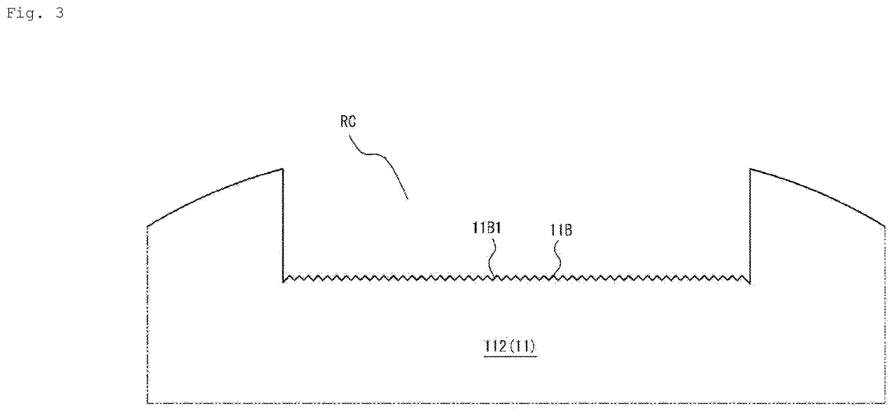

A friction coefficient of the support surface 11B is preferably a predetermined value or more. Here, the predetermined value is suitably designed by a material constituting the housing of the level gauge 6. For example, as shown in FIG. 3, the support surface 11B may set the friction coefficient to a predetermined value or more, by having a plurality of grooves 11B1. In the example shown in FIG. 3, the support surface 11B has a plurality of grooves 11B1 throughout the support surface 11B, but may have a plurality of grooves 11B1 in a part of the support surface 11B. The support surface 11B may set the friction coefficient to a predetermined value or more, by having irregularities, sand mesh surfaces, and the like on at least a part of the support surface 11B. The support surface 11B may have an arbitrary shape to be fitted to the side of the level gauge 6 abutting on the support surface 11B. Thus, the level gauge 6 is suppressed from being displaced in a direction orthogonal to a direction in which the support surface 11B supports the level gauge 6 in the state of being disposed on the support surface 11B. Therefore, since the level gauge 6 is stably supported, the worker can measure the levelness with high accuracy.

### (Installing Method for Fastening U-Bolt)

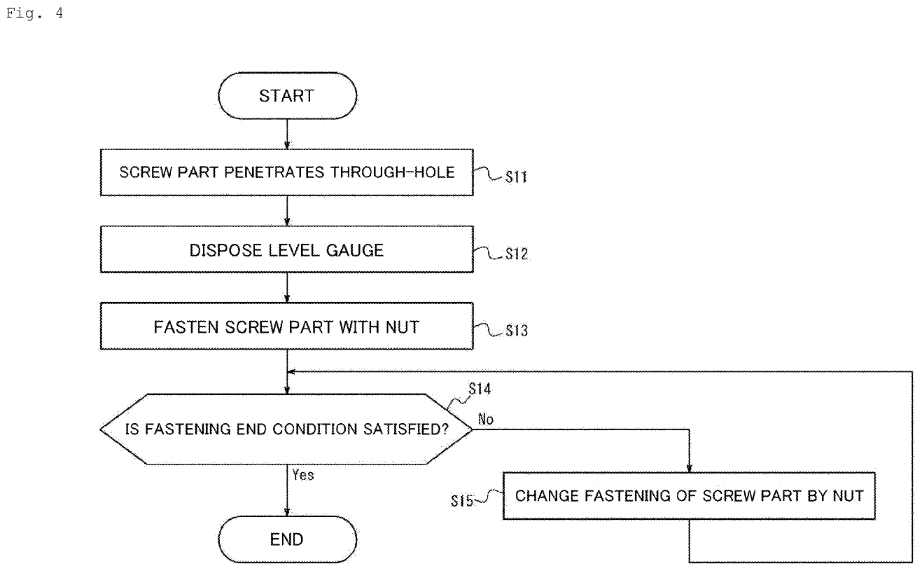

Here, the operation for fastening the U-bolt 10 according to the first embodiment will be described with reference to FIG. 4. FIG. 4 is a flow chart showing an example of the operation for fastening the U-bolt 10 according to the first embodiment. The operation for fastening the U-bolt 10 described with reference to FIG. 4 corresponds to the installing method for fastening the U-bolt 10 according to the first embodiment.

In a step S11, a worker causes the screw part 12 of the U-bolt 10 to pass through the through-hole 4.

In a step S12, the worker disposes the level gauge 6 as a supported object on the support surface 11B.

In a step S13, the worker fastens the screw part 12 by the nut 3 on the basis of the levelness indicated by the level gauge 6. Specifically, the worker fastens the screw part 12 to the nut 3 so that the levelness detected by the level gauge 6 is within a predetermined range.

In step S14, the worker determines whether the fastening end condition is satisfied At this time, the worker can use any method in determining whether the fastening end condition is satisfied. For example, when the torque of the screw part 12 measured using a torque wrench reaches a specified value, if the levelness detected by the level gauge 6 is within a predetermined range, the worker may determine whether the fastening end condition is satisfied. Further, when the screw part 12 is completely fastened by the nut 3, that is, when the nut 3 cannot be further rotated in a direction of fastening the screw part 12, if the levelness detected by the level gauge 6 is within a predetermined range, the worker may determine that the fastening end condition is satisfied. In this case, when the screw part 12 is not completely fastened by the nut 3, that is, when the nut 3 can be further rotated in the direction of fastening the screw part 12, the worker determines that the fastening end condition is not satisfied. Also, the worker determines that the fastening end condition is not satisfied, even when the levelness detected by the level gauge 6 is not within a predetermined range.

When it is determined that the fastening end condition is satisfied in the step S14, the worker ends the operation for fastening the U-bolt 10. When it is determined that the fastening end condition is not satisfied in the step S14, the worker changes fastening of the screw part 12 to the nut 3 in step S15. Here, the worker changes the fastening so that the levelness detected by the level gauge 6 is within a predetermined range. At this time, the worker may change fastening of one of the shaft part 111A and the shaft part 111B, or may change fastening of both of the shaft part 111A and the shaft part 111B.

When the fastening of the screw part 12 to the nut 3 is changed in the step S15, the processing return to the step S14 and the processing is repeated.

As described above, according to the first embodiment, a part of the surface of the body part 11 of the U-bolt 10 constitutes the support surface 11B for supporting the supported object. Thus, the worker can stably dispose the level gauge 6 on the support surface 11B. Therefore, the worker can fasten the U-bolt 10 to the fastened object 2 so that the extending direction of the shaft part 111 is substantially orthogonal to the surface of the fastened object 2, on the basis of the levelness detected by the level gauge 6. Therefore, the worker can fix the U-bolt by equalizing strains of each of the pair of shaft parts, while suppressing complication of the structure of the U-bolt 10. Accordingly, the worker can firmly fix the fastening object 1.

Especially, a part of the surface of the bridge part 112 constitutes a support surface 11B for supporting the supported object in the extending direction in which the shaft part 111 extends. Thus, the worker can stably dispose the level gauge 6 on the bridge part 112. Further, the worker can properly fasten the U-bolt 10 to the fastened object 2 having a plane in which a direction orthogonal to the horizontal direction is a perpendicular direction, on the side to which the fastening object 1 is fixed, on the basis of the levelness measured by the level gauge 6. Specifically, the worker can fasten the U-bolt 10 to the fastened object 2 so that the extending directions of the pair of shaft parts 111 are substantially orthogonal to the plane of the fastened object 2.

A part of the surface of one shaft part 111 constitutes the support surface 11B for supporting the supported object in a direction orthogonal to the extending direction in which the shaft part 111 extends. Thus, the worker can stably dispose the level gauge 6 on the shaft part 111A. The worker can properly fasten the U-bolt 10 to the fastened object 2 having a plane in which the horizontal direction is a perpendicular direction, on the side to which the fastening object 1 is fixed, on the basis of the levelness measured by the level gauge 6. Specifically, the worker can fasten the U-bolt 10 to the fastened object 2 so that the extending directions of the pair of shaft parts 111 are substantially orthogonal to the surface of the fastened object 2.

When the bridge part 112 is constituted in line symmetry with respect to a virtual line OX by making the center of the support surface 11B of the recess RC in the X-axis direction as the apex O, the lengths L of the two side faces 11S of the recess RC from the end portion on the support surface side to the end portion on the opening end side are substantially the same. Thus, when the level gauge 6 is disposed in the recess RC, the displacement of the level gauge 6 in a +Y-axis direction and the displacement in a-Y-axis direction can be similarly suppressed.

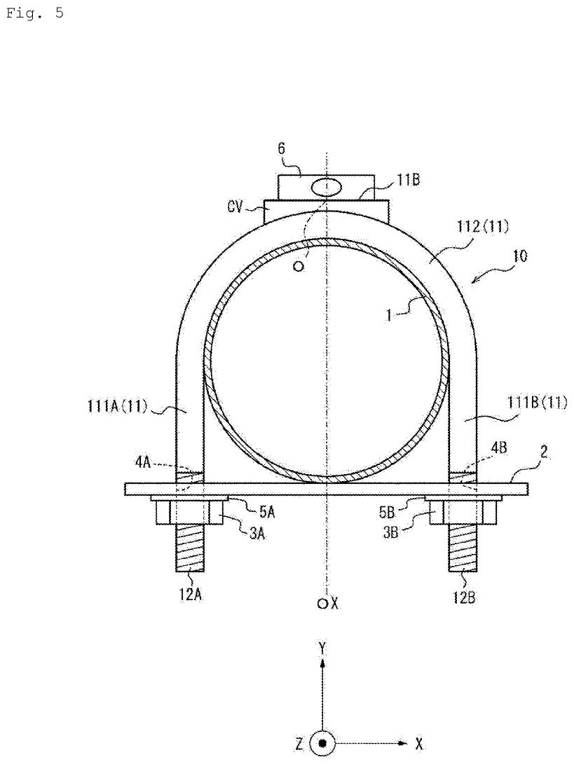

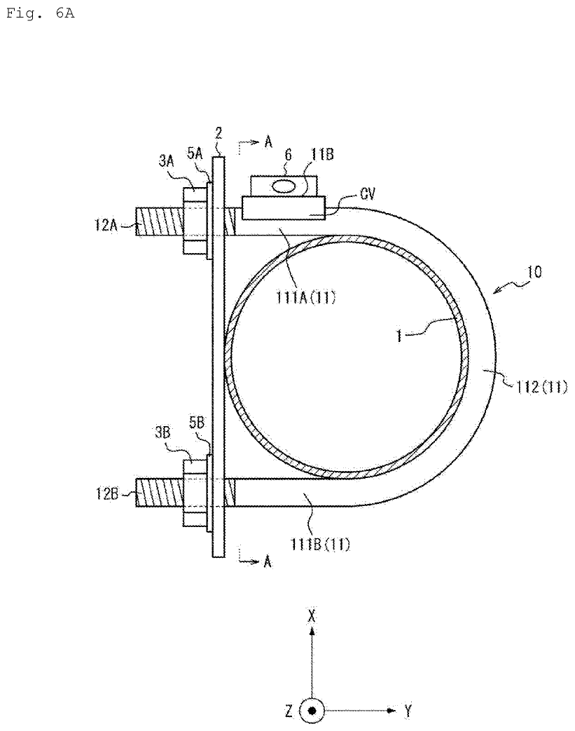

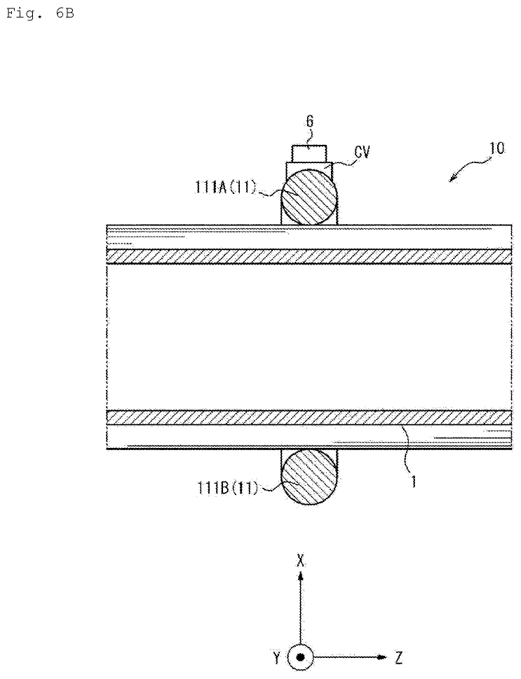

Further, in the first embodiment, although an example in which the body part 11 has the recess RC has been described, the embodiment is not limited thereto. For example, as shown in FIGS. 5, 6A and 6B, the body part 11 of the U-bolt 10 may further have a protrusion CV. In such a configuration, the support surface 11B can be a part of the surface of the protrusion CV. For example, the support surface 11B may be a surface of the protrusion CV on the opposite side to a surface on the side abutting on the body part 11.

In the example shown in FIG. 5, the protrusion CV is provided to abut against the bridge part 112. In this example, the support surface 11B is a plane in which the extending direction in which the shaft part 111 extends is the perpendicular direction. In the examples shown in FIGS. 6A and 6B, the protrusion CV is provided to abut on one shaft 111. In this example, the support surface 11B is a plane in which a direction orthogonal to the extending direction in which the shaft part 111 extends is the perpendicular direction.

The protrusion CV can be detached from the body part 11. Thus, when performing installation for fastening the body part 11 and the screw part 12 of the U-bolt 10 to the fastened object 2, the protrusion CV is attached to the body part 11, and before and after the start of the installation, the protrusion CV can be detached from the body part 11. Therefore, the worker can easily form the U-bolt 10 of the present embodiment.

### Second Embodiment

### (Configuration of U-bolt)

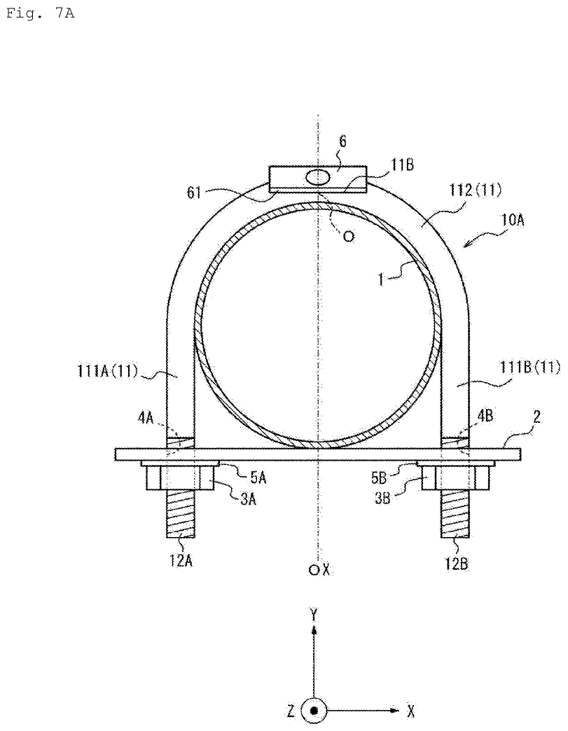

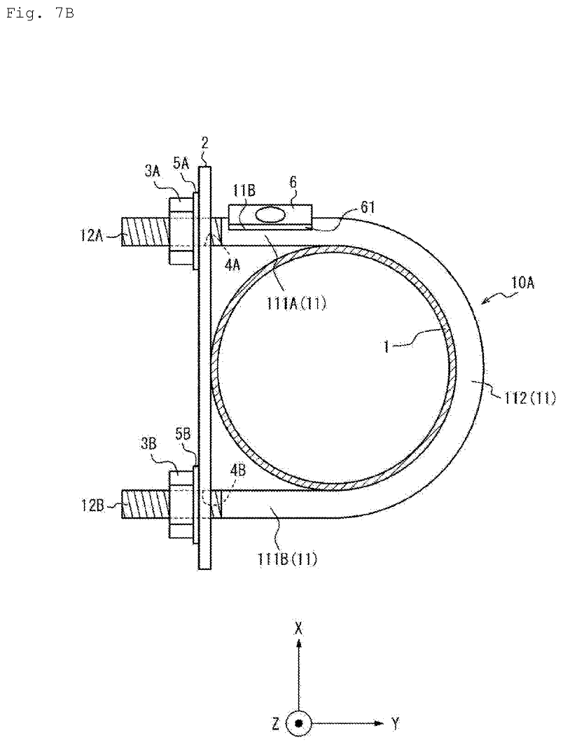

FIGS. 7A and 7B are diagrams showing a configuration example of a U-bolt 10 according to a second embodiment of the present invention.

The U-bolt 10 according to the second embodiment includes a body part 11 including a pair of shaft parts 111A and 111B and a bridge part 112, and a pair of screw parts 12A and 12B, similarly to the U-bolt 10 according to the first embodiment.

The body part 11, and the pair of screw parts 12A and 12B of the U-bolt 10 shown in FIG. 7A are similar to the body part 11, and the pair of screw parts 12A and 12B of the U-bolt 10 described with reference to FIG. 2A in the first embodiment.

The body part 11, and the pair of screw parts 12A and 12B of the U-bolt 10 shown in FIG. 7B are similar to the body part 11 of the U-bolt 10, and the pair of screw parts 12A and 12B described with reference to FIG. 2B in the first embodiment.

Unlike the level gauge 6 according to the first embodiment, the level gauge 6 according to the second embodiment further includes a magnet 61.

The magnet 61 may be provided at an arbitrary position in the level gauge 6. The magnet 61 may be provided on the side of the level gauge 6 which abuts on the support surface 11B of the body part 11.

### (Installing Method for Fastening U-Bolt)

The installing method of fastening the U-bolt 10 according to the second embodiment is the same as the installing method of fastening the U-bolt 10 according to the first embodiment.

As described above, according to the second embodiment, the level gauge 6 having the magnet 61 is disposed on the support surface 11B. Thus, the level gauge 6 disposed on the support surface 11B of the body part 11 provided in the U-bolt 10 formed by a metal having ferromagnetism such as steel can suppress an occurrence of relative displacement with respect to the body part 11. Thus, the U-bolt can be fixed by equalizing the strains of each of the pair of shaft parts, while suppressing complication of the structure of the U-bolt. Therefore, the worker can fix the U-bolt by equalizing strains of each of the pair of shaft parts, while suppressing complication of the structure of the U-bolt 10. Accordingly, the worker can firmly fix the fastening object 1.

Further, since the magnet 61 is provided on the side of the level gauge 6 which abuts on the support surface 11B of the body part 11, the level gauge 6 can further suppress an occurrence of relative displacement with respect to the body part 11.

### Third Embodiment

### (Configuration of U-Bolt)

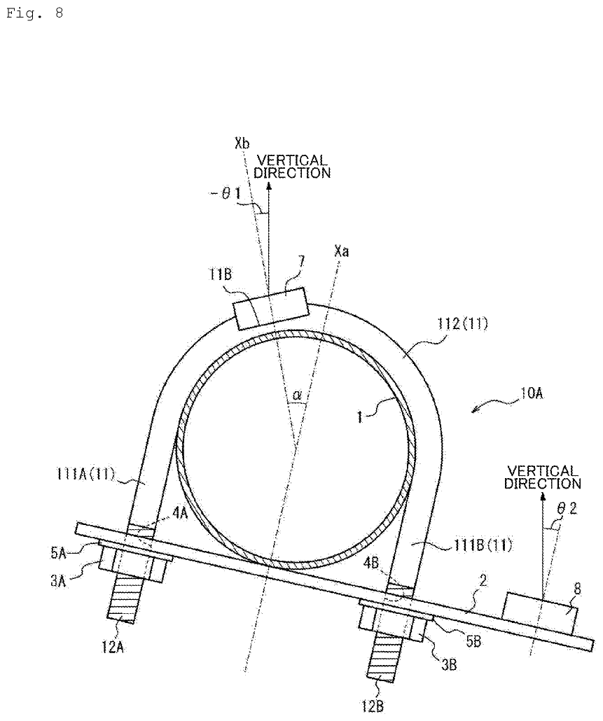

FIG. 8 is a diagram showing an exemplary configuration of a U-bolt 10 according to a third embodiment of the present invention.

The U-bolt 10 according to the third embodiment includes a body part 11 including a pair of shaft parts 111A and 111B and a bridge part 112, and a pair of screw parts 12A and 12B, similarly to the U-bolt 10 according to the first embodiment. The pair of screw parts 12A and 12B of the U-bolt 10 shown in FIG. 8 are similar to the pair of screw parts 12A and 12B of the U-bolt 10 described with reference to FIG. 1A in the first embodiment. A part of the surface of the body part 11 in the third embodiment is constituted by a support surface 11B similarly to a part of the surface of the U-bolt 10 in the The support surface 11B in the present embodiment is configured to support the supported object in a direction which forms a known predetermined angle α (a direction along which a dashed line Xb extends in FIG. 8) with respect to the extending direction (a direction along which the dashed line Xa extends in FIG. 8).

The supported object disposed on the support surface 11B of this embodiment is a gyro sensor 7 for the U-bolt (first gyro sensor). Further, a gyro sensor 8 for the fastened object (a second gyro sensor) is disposed on the fastened object 2. In the example shown in FIG. 8, the support surface 11B is constituted by a bottom surface of the recess RC included in the body part 11, but is not limited thereto. As shown in FIGS. 5, and 6A and 6B, the support surface 11B can be a part of the surface of the protrusion CV provided in the U-bolt 10.

The gyro sensor 7 for the U-bolt detects an angle θ1 of the gyro sensor 7 for the U-bolt with respect to a reference direction. The reference direction may be, for example, a vertical direction, but may be any other predetermined direction. In the example shown in FIG. 8, the angle θ1 detected by the gyro sensor 7 for the U-bolt is an angle formed by a direction perpendicular to the direction in which the gyro sensor 7 for the U-bolt extends with respect to the vertical direction. Similarly, the gyro sensor 8 for the fastened object is disposed on the fastened object 2. The gyro sensor 8 for the fastened object detects an angle θ2 of the gyro sensor 8 for the fastened object with respect to the reference direction. In the example shown in FIG. 8, the angle θ2 detected by the gyro sensor 8 for the U-bolt is an angle formed by a direction perpendicular to the direction in which the gyro sensor 8 for the U-bolt extends with respect to the vertical direction.

In such a configuration, when an angle difference θ1-θ2 between the angle θ1 detected by the gyro sensor 7 for the U-bolt and the angle θ2 detected by the gyro sensor 8 for the fastened object is a predetermined angle α, an extending direction of the shaft part 111 of the U-bolt 10 is substantially orthogonal to a surface of the fastened object 2. Therefore, the worker can determine whether the shaft part 111A and the shaft part 111B are each fastened to the nut 3A and the nut 3B approximately uniformly, on the basis of the angle difference θ1-θ2 and the predetermined angle α. Specifically, when the angle difference θ1-θ2 is within a predetermined range from a predetermined angle α, the worker can determine that the shaft part 111A and the shaft part 111B are approximately uniformly fastened to the nut 3A and the nut 3B, respectively. Further, when the angle difference θ1-θ2 is not within a predetermined range from the predetermined angle α, the worker can determine that the shaft part 111A and the shaft part 111B are not each fastened to the nut 3A and the nut 3B substantially uniformly. As an example, when the support surface 11B is configured to support the supported object in the extending direction of the shaft part 11, the predetermined angle α is 0°. In such a configuration, when the angle difference θ1-θ2 is within a predetermined range from a predetermined angle 0°, the worker can determine that the shaft part 111A and the shaft part 111B are each fastened to the nut 3A and the nut 3B substantially uniformly. As another example, when the support surface 11B is configured to support the supported object in a direction orthogonal to the extending direction of the shaft part 11, the predetermined angle α is 90°. In such a configuration, when the angle difference θ1-θ2 is within a predetermined range from a predetermined angle 90°, the worker can determine that the shaft part 111A and the shaft part 111B are each fastened to the nut 3A and the nut 3B substantially uniformly.

### (Installing Method for Fastening U-Bolt)

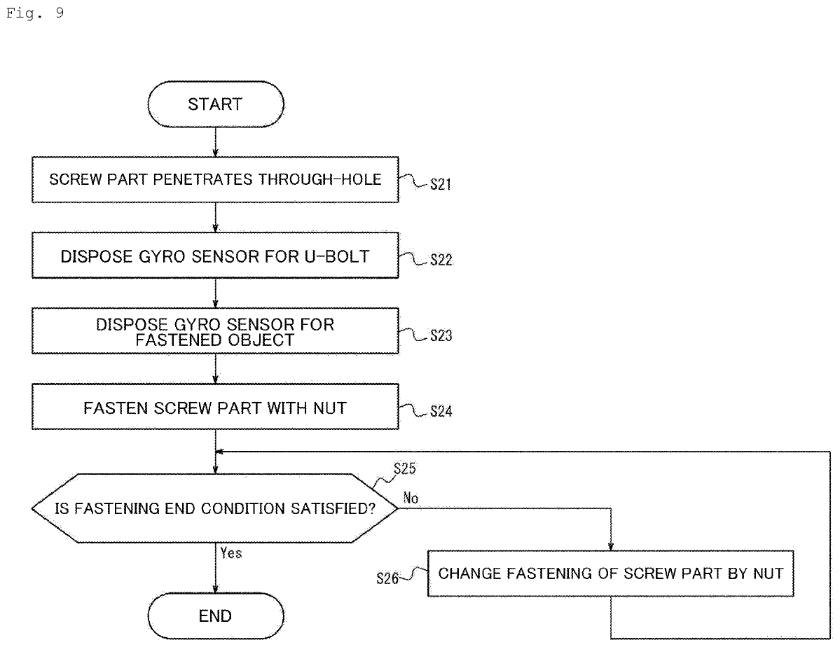

Next, an operation for fastening the U-bolt 10 according to the third embodiment will be described with reference to FIG. 9. FIG. 9 is a flow chart showing an example of the operation for fastening the U-bolt 10 according to the third embodiment. The operation for fastening the U-bolt 10 described with reference to FIG. 9 corresponds to the installing method for fastening the U-bolt 10 according to the third embodiment.

In step S21, the worker causes the screw part 12 of the U-bolt 10 to pass through the through-hole 4.

In step S22, the worker disposes the gyro sensor 7 for the U-bolt, which is a supported object, on the support surface 11B of the body part 11.

In step S23, the worker disposes the gyro sensor 8 for the fastened object on the fastened object 2.

In step S24, the worker fastens the screw part 12 by the nut 3, on the basis of the angle θ1 detected by the gyro sensor 7 for the U-bolt and the angle θ2 detected by the gyro sensor 8 for the fastened object. Specifically, the worker fastens the screw part 12 by the nut 3 so that the angle difference θ1-θ2 is within a predetermined range from a known predetermined angle α.

In step S25, the worker determines whether the fastening end condition is satisfied At this time, the worker can use any method in determining whether the fastening end condition is satisfied. For example, when the torque of the screw part 12 measured using a torque wrench reaches a predetermined value, and if the angle difference θ1-θ2 is within a predetermined range from a known predetermined angle α, the worker may determine whether the fastening end condition is satisfied. Further, when the screw part 12 is completely fastened by the nut 3, that is, when the nut 3 cannot be further rotated in a direction of fastening the screw part 12, and if the angle difference θ1-θ2 is within a predetermined range from a known predetermined angle α, the worker may determine that the fastening end condition is satisfied. In this case, when the screw part 12 is not completely fastened by the nut 3, that is, when the nut 3 can be further rotated in the direction of fastening the screw part 12, the worker determines that the fastening end condition is not satisfied. Also, even when the angle difference θ1-θ2 is not within a predetermined range from a known predetermined angle α, the worker determines that the fastening end condition is not satisfied.

When it is determined that the fastening end condition is satisfied in the step S25, the worker ends the operation for fastening the U-bolt 10. When it is determined that the fastening end condition is not satisfied in the step S24, the worker changes fastening of the screw part 12 to the nut 3 in step S26. Here, the worker changes fastening so that the angle difference θ1-θ2 is within a predetermined range from a known predetermined angle α. The worker may change the fastening of one of the shaft part 111A and the shaft part 111B, or may change the fastening of both of the shaft part 111A and the shaft part 111B.

When the fastening of the screw part 12 to the nut 3 is changed in the step S26, the processing returns to the step S25 and the processing is repeated.

In the above description, it has been explained that the processing of step S23 is executed after the processing of step S22 is executed, but this is not limited thereto. For example, the processing of step S22 may be executed after the processing of step S23 is executed, or the processing of step S22 and the processing of step S23 may be executed at the same timing.

As described above, according to the third embodiment, the supported object is the gyro sensor 7 for the U-bolt, and the gyro sensor 8 for the fastened object is disposed in the fastened object 2. Therefore, even when the direction in which the fastened object 2 is disposed is unknown, the U-bolt 10 can be fixed by equalizing strain of each of the pair of shaft parts, while suppressing complication of the structure of the U-bolt. Therefore, the worker can fix the U-bolt 10 by equalizing strain of each of the pair of shaft parts, while suppressing complication of the structure of the U-bolt 10. Accordingly, the worker can firmly fix the fastening object 1.

### REFERENCE SIGNS LIST

1 Fastening object
2 Fastened object
3, 2A, 3B Nut
4, 4A, 4B Through-hole
5, 5A, 5B Washer
6 Level gauge
7 Gyro sensor for U-bolt (first gyro sensor)
8 Gyro sensor for fastened object (second gyro sensor)
10 U-bolt
11 Body part
111, 111A, 111B Shaft part
112 Bridge part
11B Support surface
11B1 Groove
11S Side face
12, 12A, 12B Screw part
61 Magnet

1. A U-bolt fastened to a fastened object, comprising:
a body part, wherein the body part includes a pair of shaft parts and a bridge part, both shaft parts of the pair of shaft parts are aligned in a first direction and extending in a second direction orthogonal to the first direction, and the bridge part connects one set of ends of each of the pair of shaft parts; and
a pair of screw parts provided at the other set of ends of each of the pair of shaft parts,
wherein a part of a surface of the body part constitutes a support surface that supports a supported object.

2. The U-bolt according to claim 1, wherein
the support surface supports the supported object in a substantially vertical direction in a state where the U-bolt is fastened to the fastened object.

3. The U-bolt according to claim 1, wherein
the part of the surface of the bridge part constitutes the support surface that supports the supported object in the second direction.

4. The U-bolt according to claim 1, wherein
the part of the surface of one shaft part of the pair of shaft parts constitutes the support surface that supports the supported object in a direction orthogonal to the second direction.

5. The U-bolt according to claim 1, wherein
the body part includes a recess, and the support surface is constituted by a bottom surface of the recess.

6. The U-bolt according to claim 1, wherein
the supported object is a level gauge or a first gyro sensor, and
when the supported object is the first gyro sensor, a second gyro sensor is disposed on the fastened object.

7. An installing method of fastening a U-bolt to a fastened object, the installing method comprising:
disposing a level gauge on a support surface, wherein the level gauge is a supported object, the U-bolt includes a body part and a pair of screw parts, the body part further includes a pair of shaft parts and a bridge part, both shaft parts of the pair of shaft parts are aligned in a first direction and placed in a second direction orthogonal to the first direction, the bridge part connects one set of ends of each of the pair of shaft parts, the pair of screw parts is provided at the other set of ends of each of the pair of shaft parts, and a part of a surface of the body part being formed by a support surface that supports a supported object; and
fastening the screw part with a nut, on the basis of levelness indicated by the level gauge.

8. An installing method of fastening a U-bolt to a fastened object, method comprising:
a step of disposing a first gyro sensor on the support surface, wherein the first gyro sensor represents a support object,
the U-bolt includes a body part and a pair of screw parts, the body part includes a pair of shaft parts and a bridge part, both shaft parts of the pair of shaft parts are aligned in a first direction and placed in a second direction orthogonal to the first direction, the bridge part connects one set of ends of each of the pair of shaft parts, the pair of screw parts is provided at the other set of ends of each of the pair of shaft parts, and a part of a surface of the body part being formed by a support surface that supports a supported object;
disposing a second gyro sensor on the fastened object; and
fastening the screw part with a nut, on the basis of an angle detected by the first gyro sensor and an angle detected by the second gyro sensor.

9. The U-bolt according to claim 2, wherein
the part of the surface of the bridge part constitutes the support surface that supports the supported object in the second direction.

10. The U-bolt according to claim 2, wherein
the part of the surface of one shaft part of the pair of shaft parts constitutes the support surface that supports the supported object in a direction orthogonal to the second direction.

11. The U-bolt according to claim 2, wherein
the body part includes a recess, and the support surface is constituted by a bottom surface of the recess.

12. The U-bolt according to claim 2, wherein
the supported object is a level gauge or a first gyro sensor, and
when the supported object is the first gyro sensor, a second gyro sensor is disposed on the fastened object.

13. The installing method according to claim 7, wherein
the part of the surface of the bridge part constitutes the support surface that supports the supported object in the second direction.

14. The installing method according to claim 7, wherein
the part of the surface of one shaft part of the pair of shaft parts constitutes the support surface that supports the supported object in a direction orthogonal to the second direction.

15. The installing method according to claim 7, wherein
the body part includes a recess, and the support surface is constituted by a bottom surface of the recess.

16. The installing method according to claim 7, wherein
the supported object is a level gauge or a first gyro sensor, and
when the supported object is the first gyro sensor, a second gyro sensor is disposed on the fastened object.

17. The installing method according to claim 8, wherein
the part of the surface of the bridge part constitutes the support surface that supports the supported object in the second direction.

18. The installing method according to claim 8, wherein
the part of the surface of one shaft part of the pair of shaft parts constitutes the support surface that supports the supported object in a direction orthogonal to the second direction.

19. The installing method according to claim 8, wherein
the body part includes a recess, and the support surface is constituted by a bottom surface of the recess.

20. The installing method according to claim 8, wherein
the supported object is a level gauge or a first gyro sensor, and
when the supported object is the first gyro sensor, a second gyro sensor is disposed on the fastened object.
